(19) United States
(12) Patent Application Publication
(10) Pub. No.: US 2022/0288966 A1
(43) Pub. Date: Sep. 15, 2022

(54) GLASS SET AND METHOD FOR MANUFACTURING SAME

(71) Applicant: DENTSU INC., Tokyo (JP)

(72) Inventors: Kenji KITAGAWA, Tokyo (JP); Akira SHIKIYA, Tokyo (JP)

(21) Appl. No.: 17/597,996

(22) PCT Filed: Sep. 25, 2020
(86) PCT No.: PCT/JP2020/036212

§ 371 Date: Feb. 1, 2022

(30) Foreign Application Priority Data
Oct. 24, 2019 (JP) 2019-193463

(51) Int. Cl. B44F 1/10; A47G 19/22

(52) U.S. Cl. CPC B44F 1/10; A47G 19/2227

(57) ABSTRACT

Provided is a glass set including: a first glass product to which a part of a predetermined mark is visibly attached; and a second glass product to which another part of the predetermined mark is visibly attached, wherein by arranging the first glass product and the second product at a predetermined positional relationship, the predetermined mark become visible. The first glass product and the second glass product may be cups made of glass. Alternately, the first glass product and the second glass product are dishes made of glass.

### TECHNICAL FIELD

The present invention relates to a glass set and a method for manufacturing the same.

### BACKGROUND ART

A patent literature 1 discloses a decoration glass formed of two window glasses. By bonding polarized films having a desired shape whose optical axes are different from each other to the two window glasses and stacking them, the shape stands out.

### CITATION LIST

### Patent Literature

Patent Literature 1: JPH05-96036U

### SUMMARY OF INVENTION

### Technical Problem

However, only when two polarized films are stacked, the shape stands out, and when not stacked, the shape does not stand out.

The object of the present invention is to provide novel glass set and a method for manufacturing the same.

### Solution to Problem

According to an embodiment of the present invention, provided is a glass set comprising: a first glass product to which a part of a predetermined mark is visibly attached; and a second glass product to which another part of the predetermined mark is visibly attached, wherein by arranging the first glass product and the second product at a predetermined positional relationship, the predetermined mark become visible.

The first glass product and the second glass product may be cups made of glass, the first glass product may have a size so that the first glass product fit in the second glass product, and arranging at the predetermined positional relationship may be fitting the first glass product in the second glass product.

The first glass product and the second glass product may be dishes made of glass, and arranging at the predetermined positional relationship may laying the first glass product on the second glass product.

The predetermined mark may include a word. The predetermined mark may include a first word represented by a language and a second word represented by another language, the first word corresponding to the second word. When the first glass product and the second glass product are not at the predetermined positional relationship, the word may not be visible as a word.

According to another embodiment of the present invention, provided is a method for manufacturing a glass set, comprising: visibly attaching a part of a predetermined mark to a first glass product; and visibly attaching another part of the predetermined mark to a second glass product; wherein by arranging the first glass product and the second product at a predetermined positional relationship, the predetermined mark become visible.

The part of the predetermined mark may be formed on the first glass product by sand blast or printing, and the another part of the predetermined mark may be formed on the second glass product by sand blast or printing.

Attaching the part of the predetermined mark may comprise forming a uniform first plane on a surface of the first glass, and attaching the part of the predetermined mark on the first plane, and attaching the another part of the predetermined mark may comprise forming a uniform second plane on a surface of the second glass, and attaching the another part of the predetermined mark on the second plane.

The first plane may be formed on a surface of the first glass by faceting, and the second plane may be formed on a surface of the first glass by faceting.

### Advantageous Effects of Invention

A glass set and a method for manufacturing the same are provided, which are novel in that even when the first glass product and the second product are not at the predetermined positional relationship, the predetermined mark is partially visible and that by arranging the both glass products at the predetermined positional relationship, the mark become visible.

### BRIEF DESCRIPTION OF DRAWINGS

FIG. 1 is a front view of the cup set 100 according to a first embodiment.

FIG. 2 is a diagram showing the cup set 100 in a state where the cup 1 is fit in the cup 2.

FIG. 3 is a front view of the dish set 200 according to a second embodiment.

FIG. 4 is a diagram showing the dish set 200 in a state where the dish 5 is laid on the dish 6.

### DESCRIPTION OF EMBODIMENTS

Hereinafter, the embodiments according to the present invention will be described specifically with reference to the drawings.

### First Embodiment

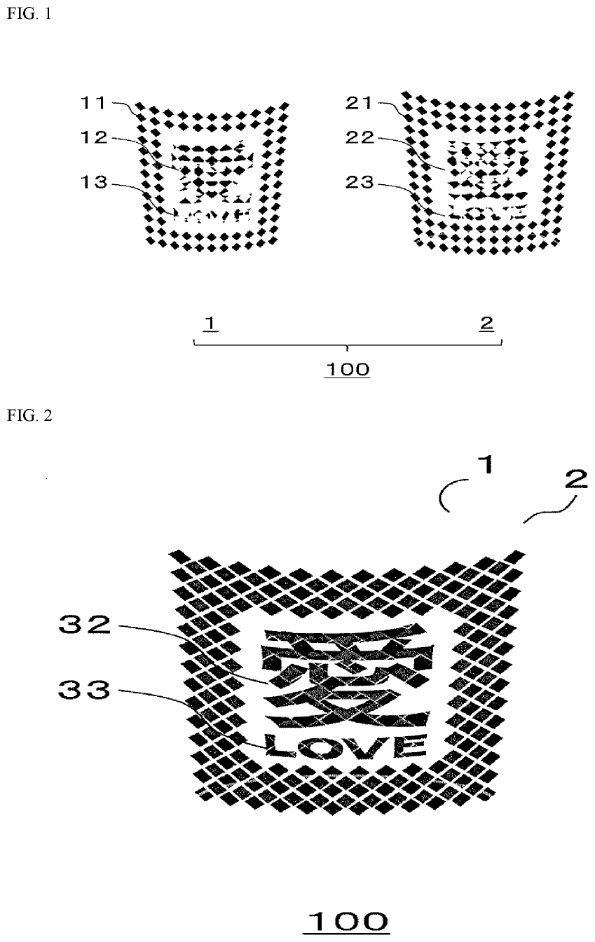

FIG. 1 is a front view of the cup set 100. This cup set 100 is an example of a glass set, and includes cups 1 and 2 made of glass. The cup 2 is a little larger than the cup 1, and it is possible to fit the cup 1 in the cup 2.

A checked pattern 11, a part 12 obtained by arbitrarily dividing a word “AI” (“love” in Japanese, expressed by Chinese character, hereinafter, “AI”), and a part 13 obtained by arbitrarily dividing the word “LOVE” are attached to the cup 1. These may be mono-colored (for example, red) or multi-colored. The other parts where these are not attached are transparent. It is preferable that, when seeing the cup 1 only, the part 12 of the word “AI” is partially visible but that it is not recognized the part 12 of the word “AI” as “AI”. Similarly, it is preferable that the part 13 of the word “LOVE” is partially visible but that it is not recognized the part 13 of the word “LOVE” as “LOVE”.

As an example of a method for manufacturing the cup 1, the checked pattern 11, the part 12 of the word “AI” and the part 13 of the word “LOVE” may be formed on an outer surface of the cup 1 by sand blast or printing. Alternatively, it is possible to firstly form a uniform plane of a surface of the cup 1 by faceting (hira-kiriko) and then form them on the plane.

A checked pattern 21, a different part 22 obtained by arbitrarily dividing Japanese word “AI”, and a different part 23 obtained by arbitrarily dividing the word “LOVE” are attached to the cup 2. These may be mono-colored (for example, navy blue, which is different from the cup 1) or multi-colored. The other parts where these are not attached are transparent. It is preferable that, when seeing the cup 2 only, the different part 22 of the word “AI” is partially visible but that it is not recognized the different part 22 of the word “AI” as “AI”. Similarly, it is preferable that the different part 23 of the word “LOVE” is partially visible but that it is not recognized the different part 23 of the word “LOVE” as “LOVE”.

As an example of a method for manufacturing the cup 2, the checked pattern 21, the different part 22 of the word “AI” and the different part 23 of the word “LOVE” may be formed on an outer surface of the cup 2 by sand blast or printing. Alternatively, it is possible to firstly form a uniform plane of a surface of the cup 2 by faceting (hira-kiriko) and then form them on the plane.

By fitting the cup 1 in the cup 2 to overlap each other (perform positioning), the hidden word “AI” 32 and the hidden word “LOVE” 33 become visible (appear) where the checked patterns 11 and 21 are base (FIG. 2).

### Second Embodiment

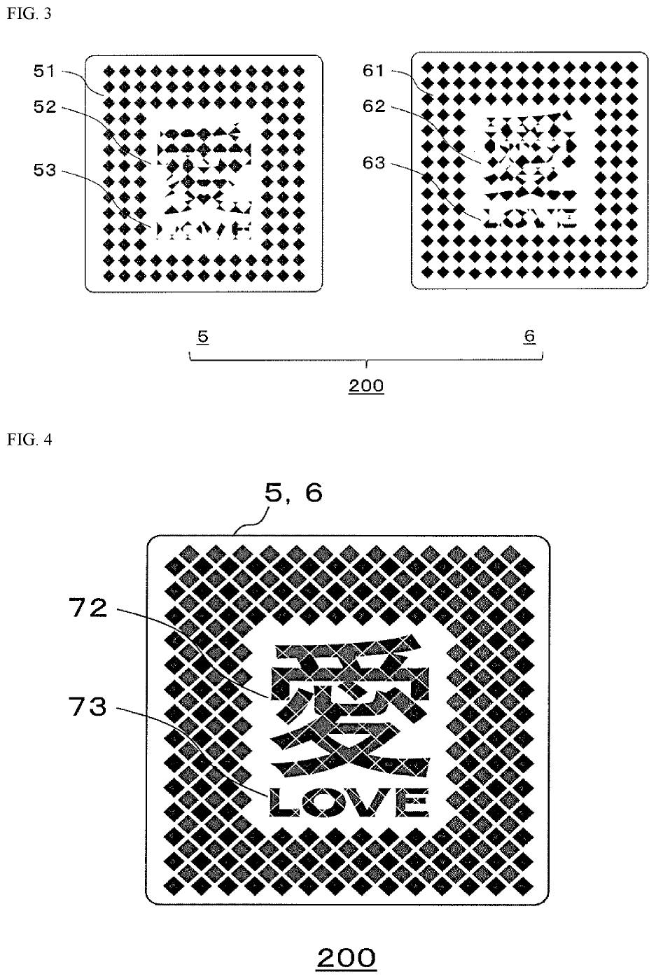

FIG. 3 is a front view of the dish set 200 according to a second embodiment. This dish set 200 is an example of a glass set, and includes dishes 5 and 6 made of glass. The shape of the dish 5 is substantially identical to that of the dish 6, and it is possible to lay the dish 5 on the dish 6 and lay the dish 6 on the dish 5.

A checked pattern 51, a part 52 obtained by arbitrarily dividing Japanese word “AI”, and a part 53 obtained by arbitrarily dividing the word “LOVE” are attached to the dish 5. These may be mono-colored (for example, red) or multi-colored. The other parts where these are not attached are transparent. It is preferable that, when seeing the dish 5 only, the part 52 of the word “AI” is partially visible but that it is not recognized the part 52 of the word “AI” as “AI”. Similarly, it is preferable that the part 53 of the word “LOVE” is partially visible but that it is not recognized the part 53 of the word “LOVE” as “LOVE”.

As an example of a method for manufacturing the dish 5, the checked pattern 51, the part 52 of the word “AI” and the part 53 of the word “LOVE” may be formed on a surface (top face and/or bottom face) of the dish 5 by sand blast or printing. Alternatively, it is possible to firstly form a uniform plane of a surface of the dish 5 by faceting (hira-kiriko) and then form them on the plane.

A checked pattern 61, a different part 62 obtained by arbitrarily dividing Japanese word “AI”, and a different part 63 obtained by arbitrarily dividing the word “LOVE” are attached to the dish 6. These may be mono-colored (for example, navy blue, which is different from the dish 5) or multi-colored. The other parts where these are not attached are transparent. It is preferable that, when seeing the dish 6 only, the different part 62 of the word “AI” is partially visible but that it is not recognized the different part 62 of the word “AI” as “AI”. Similarly, it is preferable that the different part 63 of the word “LOVE” is partially visible but that it is not recognized the different part 63 of the word “LOVE” as “LOVE”.

As an example of a method for manufacturing the dish 6, the checked pattern 61, the different part 62 of the word “AI” and the different part 63 of the word “LOVE” may be formed on a surface (top face and/or bottom face) of the dish 6 by sand blast or printing. Alternatively, it is possible to firstly form a uniform plane of a surface of the dish 6 by faceting (hira-kiriko) and then form them on the plane.

By overlapping the dishes 5 and 6 each other (perform positioning), the hidden word “AI” 72 and the hidden word “LOVE” 73 become visible (appear) where the checked patterns 51 and 61 are base (FIG. 4).

In the above mentioned first (second) embodiment, it is preferable that checked patterns 11, 12 which are suitable for Kiriko are attached to the cups 1, 2 (dishes 5, 6) but another pattern or no pattern may be attached.

Further, what becomes visible by overlapping, may be words whose meanings and/or concepts are common (corresponding) to each other but whose languages are different from each other, such as “AI” and “LOVE”. For example, in a case of a gift such as a cup or a dish, in addition to Japanese word “AI” and “LOVE”, Japanese word “Bi” (“beauty” in Japanese, expressed by Chinese character) and “BEAUTY”, Japanese word “SEI” (“life” in Japanese, expressed by Chinese character) and “LIFE”, Japanese word “FUKU” (“lucky” in Japanese, expressed by Chinese character) and “LUCKY” are preferable. As a language, for example, one is Japanese (Chinese character) and the other is English, French, German or Russian. Of course, it is possible to set only one language, two or more languages and any marks may be visible.

Further, not limited to the cup and dish explained in the first and second embodiments, it is enough for words to be visible by arranging any two or more glass products at a predetermined positional relationship.

The above embodiments are described so that a person with an ordinary skill in the technical field to which the invention pertains can implement the invention. Various modified examples of the above embodiments can be naturally made by those skilled in the art, and the technical idea of the invention can be applied to other embodiments. Therefore, the invention is not limited to the described embodiments and should encompass the widest range in accordance with the technical ideas defined by the claims. Further, the invention can be applied not only to ships and vehicles, but also to arbitrary conveyances.

### REFERENCE SIGNS LIST

100 glass set
1, 2 cup set
11, 12 checked pattern
12, 22 a part of word “AI”
13, 23 a part of word “LOVE”
32 word “AI”
33 word “LOVE”
200 dish set
5, 6 dish
51, 61 checked pattern
52, 62 a part of word “AI”
53, 63 a part of word “LOVE”
72 word “AI”
73 word “LOVE”

What is claimed is:

1. A glass set comprising:
a first glass product to which a first part of a first mark is visibly attached; the first part being obtained by dividing the first mark, and
a second glass product to which second part of the first mark is visibly attached, the second part being obtained by dividing the first mark,
wherein by arranging the first glass product and the second product at a first positional relationship, the first mark become visible.

2. The glass set of claim 1, wherein
the first glass product and the second glass product are cups made of glass,
the first glass product has a size so that the first glass product fit in the second glass product, and
arranging at the first positional relationship is fitting the first glass product in the second glass product.

3. The glass set of claim 1, wherein
the first glass product and the second glass product are dishes made of glass, and
arranging at the first positional relationship is laying the first glass product on the second glass product.

4. The glass set of claim 1, wherein the first mark includes a word.

5. The glass set of claim 4, wherein the first mark includes a first word represented by a first language and a second word represented by second language, the first word corresponding to the second word.

6. The glass set of claim 1, wherein when the first glass product and the second glass product are not at the first positional relationship, the first mark is not visible as a word.

7. A method for manufacturing a glass set, comprising:
visibly attaching a part of a first mark to a first glass product, the first part being obtained by dividing the first mark; and
visibly attaching second part of the first mark to a second glass product, the second part being obtained by dividing the first mark;
wherein by arranging the first glass product and the second product at a first positional relationship, the first mark become visible.

8. The method of claim 7, wherein
the first part of the first mark is formed on the first glass product by sand blast or printing, and
the second part of the first mark is formed on the second glass product by sand blast or printing.

9. The method of claim 7, wherein
attaching the first part of the first mark comprises forming a uniform first plane on a surface of the first glass product, and attaching the first part of the first mark on the first plane, and
attaching the second part of the first mark comprises forming a uniform second plane on a surface of the second glass product, and attaching the second part of the predetermined mark on the second plane.

10. The method of claim 9, wherein
the first plane is formed on a surface of the first glass product by faceting, and
the second plane is formed on a surface of the first glass product by faceting.
